(19) United States
(12) Patent Application Publication
(10) Pub. No.: US 2022/0389651 A1
(43) Pub. Date: Dec. 8, 2022

(54) COLORED POLYPROPYLENE RESIN COMPOSITION AND METHOD OF PRODUCING THE COMPOSITION

(71) Applicant: CANON KABUSHIKI KAISHA, Tokyo (JP)

(72) Inventors: Taichi Shintou, Saitama (JP); Koromo Shirota, Kanagawa (JP); Tsuyoshi Santo, Kanagawa (JP)

(21) Appl. No.: 17/734,207

(22) Filed: May 2, 2022

(30) Foreign Application Priority Data
May 18, 2021 (JP) 2021-083562
Mar. 31, 2022 (JP) 2022-057944

(51) Int. Cl. D06P 3/79; D06P 1/94

(52) U.S. Cl. CPC D06P 3/794; D06P 1/94; D10B 2401/14; D10B 2321/022; D10B 2501/00; D10B 2507/00

(57) ABSTRACT

Provided is a colored polypropylene resin composition, which is excellent in high color developability, washing resistance, and sublimation resistance, and can be stably supplied. The colored polypropylene resin composition includes a polypropylene resin and a colorant, and is characterized by including a compound having a predetermined structure as the colorant.

### BACKGROUND OF THE INVENTION

### Field of the Invention

The present invention relates to a colored polypropylene resin composition and a method of producing the composition.

### Description of the Related Art

A polypropylene (hereinafter sometimes abbreviated as “PP”) resin is one of general-purpose resins. The polypropylene (PP) resin has, for example, the following characteristics. The resin is lighter than water (has a specific gravity of 0.92), and is excellent in quick-drying property, heat resistance, chemical resistance, antistatic property, scratch resistance, and bending resistance. The resin has been used in various fields through exploitation of the characteristics. For example, a fiber product such as a nonwoven fabric is inexpensive, is relatively satisfactory in terms of mechanical property and spinning property, and is excellent in processability. Meanwhile, the product is required to have a dyeing property or a coloring affinity. However, the mainstream of the industrial coloring of polypropylene has been a production method including adding an organic or inorganic pigment in a spinning step to subject the polypropylene to spin-dyeing, or a production method including, for example, directly kneading the organic pigment into the resin. The methods each still involve such many problems as described below. The colored polypropylene is poor in vividness and color variation, is unsuitable for print processing, has a thick yarn, and has a rough texture. Accordingly, the methods have been hardly utilized in the fields of apparel clothing and sportswear. In recent years, a dyeing method including using an anthraquinone dye has been reported as a method of dyeing the polypropylene resin (fiber) (International Publication No. WO2018/123811 and International Publication No. WO2019/146174).

### SUMMARY OF THE INVENTION

The anthraquinone dye described in each of the above-mentioned literatures has involved a problem in that the dye has high aggregability, and is not sufficient in terms of color developability (vividness) and washing resistance. In addition, the dye has involved a problem in that the dye sublimates owing to an increase in temperature in a ship at the time of its transportation by ship to migrate to an adjacent pale color. Further, in recent years, in view of, for example, ease of availability of a raw material for the dye, concern in terms of stable supply has been pointed out. Accordingly, there has been an earnest desire for the development of a dye and a colored polypropylene resin composition, each of which can dye a polypropylene resin with high color developability (vividness) in many fields, in particular, an apparel or sportswear field where a design property and functionality are required, is excellent in washing resistance and sublimation resistance, and can be stably supplied.

The present invention relates to a colored polypropylene resin composition including: a polypropylene resin; and a colorant, wherein the colorant contains at least one or more kinds of compounds represented by the following general formulae (1) to (4):

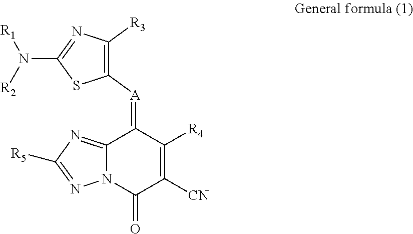

in the general formula (1), R₁ and R₂ each independently represent an alkyl group having 1 to 12 carbon atoms, R₃ represents an alkyl group having 1 to 4 carbon atoms, a phenyl group having a substituent, or an unsubstituted phenyl group, R₄ represents an alkyl group having 1 to 4 carbon atoms, or an unsubstituted phenyl group, R₅ represents an alkyl group having 1 to 12 carbon atoms, an unsubstituted phenyl group, a benzyl group, a dialkylamino group, or a diphenylamino group, and A represents a carbon atom or a nitrogen atom, and when A represents a carbon atom, one hydrogen atom is bonded to the carbon atom;

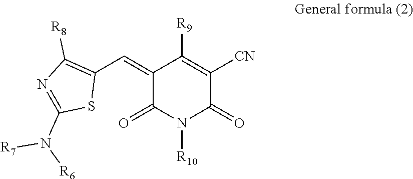

in the general formula (2), R₆ and R₇ each independently represent a linear alkyl group having 1 to 12 carbon atoms, a branched alkyl group having 3 to 12 carbon atoms, or a cyclic alkyl group having 3 to 12 carbon atoms, R₈ represents a linear alkyl group having 1 to 4 carbon atoms, a branched alkyl group having 1 to 4 carbon atoms, a phenyl group that may be substituted, or an unsubstituted phenyl group, R₉ represents a linear alkyl group having 1 to 12 carbon atoms, or a branched alkyl group having 1 to 12 carbon atoms, R₁₀ represents a hydrogen atom, an alkyl group, an aryl group, a benzyl group, or —NR₁₁R₁₂, and R₁₁ and R₁₂ each independently represent a hydrogen atom, an unsubstituted alkyl group, an alkyl group having a substituent, an unsubstituted aryl group, an aryl group having a substituent, an unsubstituted acyl group, or an acyl group having a substituent, and R₁₁ and R₁₂ represent a ring formed by bonding thereof to each other;

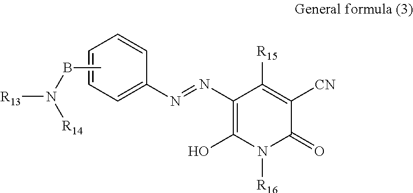

in the general formula (3), B represents a carbonyl group or a sulfonyl group, R₁₃ and R₁₄ each independently represent a linear alkyl group having 1 to 12 carbon atoms, a branched alkyl group having 3 to 12 carbon atoms, or a cyclic alkyl group having 3 to 12 carbon atoms, R₁₅ represents a linear alkyl group having 1 to 12 carbon atoms, or a branched alkyl group having 1 to 12 carbon atoms, R₁₆ represents a hydrogen atom, an alkyl group, an aryl group, a benzyl group, or —NR₁₇R₁₈, and R₁₇ and R₁₈ each independently represent a hydrogen atom, an unsubstituted alkyl group, an alkyl group having a substituent, an unsubstituted aryl group, an aryl group having a substituent, an unsubstituted acyl group, or an acyl group having a substituent, and R₁₇ and R₁₈ represent a ring formed by bonding thereof to each other;

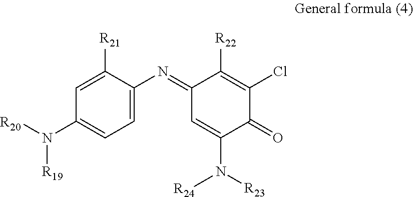

in the general formula (4), R₁₉ and R₂₀ each independently represent a linear alkyl group having 1 to 12 carbon atoms, a branched alkyl group having 3 to 12 carbon atoms, or a cyclic alkyl group having 3 to 12 carbon atoms, and R₂₁ represents a linear alkyl group having 1 to 4 carbon atoms, R₂₂ represents a linear alkyl group having 1 to 12 carbon atoms, or a branched alkyl group having 1 to 12 carbon atoms, and R₂₃ and R₂₄ each independently represent a hydrogen atom, an unsubstituted alkyl group, an alkyl group having a substituent, an unsubstituted aryl group, an aryl group having a substituent, an unsubstituted acyl group, or an acyl group having a substituent, and R₂₃ and R₂₄ represent a ring formed by bonding thereof to each other.

The present invention also relates to a method of producing a colored polypropylene resin composition having the above-mentioned configuration, the method including coloring a polypropylene resin with a colorant in supercritical carbon dioxide to be used as a medium.

According to the present invention, there can be provided the colored polypropylene resin composition, which is excellent in high color developability, washing resistance, and sublimation resistance, and can be stably supplied.

In addition, according to the present invention, there can be provided the method of producing a colored polypropylene resin composition, which is excellent in high color developability, washing resistance, and sublimation resistance, and can be stably supplied, the method being characterized in that the colorant is highly dispersed in the polypropylene resin through use of the supercritical carbon dioxide as a medium.

Further features of the present invention will become apparent from the following description of exemplary embodiments.

### DESCRIPTION OF THE EMBODIMENTS

Embodiments of the present invention are described in detail below. However, the present invention is not limited thereto. In the present invention, the description “from 00 to xx” representing a numerical range such as the number of carbon atoms means a numerical range including a lower limit and an upper limit that are end points unless otherwise stated.

The inventors of the present invention have made extensive investigations with a view to solving the above-mentioned problems, and as a result, have found that a colored polypropylene resin composition, which is excellent in high color developability, washing resistance, and sublimation resistance, and can be stably supplied, can be provided by using a colored polypropylene resin composition including a polypropylene resin and a colorant, the composition being characterized in that the colorant contains at least one or more kinds of compounds represented by the following general formulae (1) to (4):

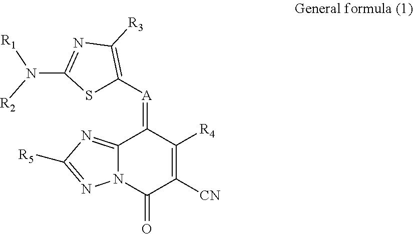

in the general formula (1), R₁ and R₂ each independently represent an alkyl group having 1 to 12 carbon atoms, R₃ represents an alkyl group having 1 to 4 carbon atoms, a phenyl group having a substituent, or an unsubstituted phenyl group, R₄ represents an alkyl group having 1 to 4 carbon atoms, or an unsubstituted phenyl group, R₅ represents an alkyl group having 1 to 12 carbon atoms, an unsubstituted phenyl group, a benzyl group, a dialkylamino group, or a diphenylamino group, and A represents a carbon atom or a nitrogen atom, and when A represents a carbon atom, one hydrogen atom is bonded to the carbon atom;

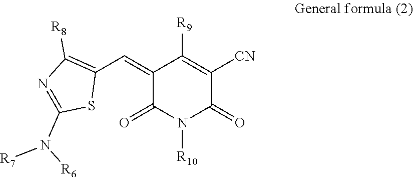

in the general formula (2), R₆ and R₇ each independently represent a linear alkyl group having 1 to 12 carbon atoms, a branched alkyl group having 3 to 12 carbon atoms, or a cyclic alkyl group having 3 to 12 carbon atoms, R₈ represents a linear alkyl group having 1 to 4 carbon atoms, a branched alkyl group having 1 to 4 carbon atoms, a phenyl group that may be substituted, or an unsubstituted phenyl group, R₉ represents a linear alkyl group having 1 to 12 carbon atoms, or a branched alkyl group having 1 to 12 carbon atoms, R₁₀ represents a hydrogen atom, an alkyl group, an aryl group, a benzyl group, or —NR₁₁R₁₂, and R₁₁ and R₁₂ each independently represent a hydrogen atom, an unsubstituted alkyl group, an alkyl group having a substituent, an unsubstituted aryl group, an aryl group having a substituent, an unsubstituted acyl group, or an acyl group having a substituent, and R₁₁ and R₁₂ represent a ring formed by bonding thereof to each other;

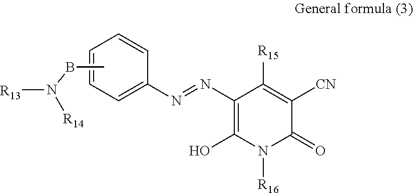

in the general formula (3), B represents a carbonyl group or a sulfonyl group, R₁₃ and R₁₄ each independently represent a linear alkyl group having 1 to 12 carbon atoms, a branched alkyl group having 3 to 12 carbon atoms, or a cyclic alkyl group having 3 to 12 carbon atoms, R₁₅ represents a linear alkyl group having 1 to 12 carbon atoms, or a branched alkyl group having 1 to 12 carbon atoms, R₁₆ represents a hydrogen atom, an alkyl group, an aryl group, a benzyl group, or —NR₁₇R₁₈, and R₁₇ and R₁₈ each independently represent a hydrogen atom, an unsubstituted alkyl group, an alkyl group having a substituent, an unsubstituted aryl group, an aryl group having a substituent, an unsubstituted acyl group, or an acyl group having a substituent, and R₁₇ and R₁₈ represent a ring formed by bonding thereof to each other;

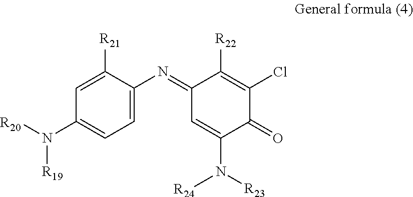

in the general formula (4), R₁₉ and R₂₀ each independently represent a linear alkyl group having 1 to 12 carbon atoms, a branched alkyl group having 3 to 12 carbon atoms, or a cyclic alkyl group having 3 to 12 carbon atoms, and R₂₁ represents a linear alkyl group having 1 to 4 carbon atoms, R₂₂ represents a linear alkyl group having 1 to 12 carbon atoms, or a branched alkyl group having 1 to 12 carbon atoms, and R₂₃ and R₂₄ each independently represent a hydrogen atom, an unsubstituted alkyl group, an alkyl group having a substituent, an unsubstituted aryl group, an aryl group having a substituent, an unsubstituted acyl group, or an acyl group having a substituent, and R₂₃ and R₂₄ represent a ring formed by bonding thereof to each other.

The colored polypropylene resin composition of the present invention may be produced by uniformly dispersing the colorant in the polypropylene resin after the dissolution of the colorant in carbon dioxide through the establishment of a supercritical carbon dioxide state.

A dyeing mechanism at this time is conceived to be as described below. A pressure-resistant container containing carbon dioxide, the colorant, and polypropylene fibers is brought into a supercritical carbon dioxide state at high temperature and high pressure. When the supercritical carbon dioxide state is established, such steps as described below occur:
(1) the colorant is solvated with (dissolved in) supercritical carbon dioxide;
(2) the free volume of a polypropylene polymer is increased by heating;
(3) the colorant solvated with the supercritical carbon dioxide diffuses in a gap in the amorphous portion of the polypropylene polymer;
(4) the colorant adsorbs to the polymer for forming the fibers;
(5) when the container is subjected to heat release and pressure release, the gap in a polymer chain returns to its original state, and hence the colorant fixes to the fibers; and
(6) when the fibers are washed with acetone or the like, the absence of compatibility between the fibers and the colorant leads to the decoloring of the fibers.
Herein, the inventors have conceived that the solvation (solubility) between the supercritical carbon dioxide and the colorant, and the compatibility between the PP fibers and the colorant serve as key points.

Each of the compounds represented by the general formulae (1) to (4) of the present invention is characterized in that the compound is easily dissolved in an aliphatic hydrocarbon-based solvent (e.g., hexane or heptane). The dissolution of each of the compounds in carbon dioxide in a supercritical state closely resembles that in the aliphatic hydrocarbon-based solvent. Accordingly, when the supercritical carbon dioxide state is established, the coloring matter of the colorant is dissolved in the carbon dioxide, and hence the colorant can be uniformly dispersed in the polypropylene resin. Meanwhile, the inventors have assumed that the compounds represented by the general formulae (1) to (4) of the present invention each have an alkyl group, and hence the compatibility of each of the compounds with the PP fibers is improved to provide a colored polypropylene resin composition, which is excellent in high color developability, washing resistance, and sublimation resistance, and can be stably supplied.

Meanwhile, anthraquinone-based compounds that have heretofore been known are each hardly dissolved in the aliphatic hydrocarbon-based solvent, and are hence a group of compounds that are also hardly dissolved in supercritical carbon dioxide.

<Compound Represented by General Formula (1)>
First, the compound represented by the general formula (1) is described.

The alkyl group having 1 to 12 carbon atoms in each of R₁ and R₂ in the general formula (1) is not particularly limited, and may be any one of linear, branched, and cyclic alkyl groups. Specific examples thereof include a methyl group, an ethyl group, a n-propyl group, an iso-propyl group, a n-butyl group, a sec-butyl group, a tert-butyl group, a n-hexyl group, a n-heptyl group, a n-octyl group, a n-nonyl group, a n-decyl group, a n-undecyl group, a n-dodecyl group, a 2-ethylhexyl group, and a cyclohexyl group.

Of those, a branched alkyl group having 6 to 12 carbon atoms is preferred, and a 2-ethylhexyl group is particularly preferred because the colored polypropylene resin composition is excellent in high color developability, washing resistance, and sublimation resistance, and can be stably supplied.

With regard to the cyclic alkyl group, in the case of, for example, a “cyclic alkyl group having 8 carbon atoms,” the group may have a cyclic structure having 8 carbon atoms, or may have a structure in which an alkyl group having 2 carbon atoms is bonded to a cyclic structure having 6 carbon atoms.

The alkyl group having 1 to 4 carbon atoms in R₃ in the general formula (1) is not particularly limited, and may be any one of linear and branched groups. Specific examples thereof include: primary alkyl groups, such as a methyl group, an ethyl group, a n-propyl group, and a n-butyl group; secondary alkyl groups, such as an iso-propyl group and a sec-butyl group; and tertiary alkyl groups such as a tert-butyl group. Of those, a tert-butyl group is preferred from the viewpoint that the colored polypropylene resin composition is excellent in high color developability, washing resistance, and sublimation resistance, and can be stably supplied.

When R₃ in the general formula (1) represents a phenyl group having a substituent, the number of its carbon atoms including that of the substituent is preferably from 6 to 20. Examples of the substituent include an alkyl group and an alkoxy group. In addition, the number of the substituents may be one or two or more. Specific examples thereof include a 4-methylphenyl group, a 2,4-dimethylphenyl group, a 2,6-dimethylphenyl group, a 3,5-dimethylphenyl group, a 2,4,6-trimethylphenyl group, a pentamethylphenyl group, a 4-methoxyphenyl group, a 2,6-dimethoxyphenyl group, a 2,4-dimethoxyphenyl group, a 3,5-dimethoxyphenyl group, and a 2,4,6-trimethoxyphenyl group. Of those, an unsubstituted phenyl group or a 4-methylphenyl group is preferred from the viewpoint that the colored polypropylene resin composition is excellent in high color developability, washing resistance, and sublimation resistance, and can be stably supplied. It is also preferred that R₃ represent an unsubstituted phenyl group.

The alkyl group having 1 to 4 carbon atoms in R₄ in the general formula (1) is not particularly limited, and may be any one of linear and branched groups. Specific examples thereof include a methyl group, an ethyl group, a n-propyl group, an iso-propyl group, a n-butyl group, a sec-butyl group, and a tert-butyl group. Of those, a methyl group or an ethyl group is preferred from the viewpoint that the colored polypropylene resin composition is excellent in high color developability, washing resistance, and sublimation resistance, and can be stably supplied.

The alkyl group having 1 to 12 carbon atoms in R₅ in the general formula (1) is not particularly limited, and may be any one of linear, branched, and cyclic groups. Specific examples thereof include a methyl group, an ethyl group, a n-propyl group, an iso-propyl group, a n-butyl group, a sec-butyl group, a tert-butyl group, a pentyl group, a neopentyl group, a hexyl group, a heptyl group, an octyl group, a cyclopropyl group, a cyclobutyl group, a cyclopentyl group, a cyclohexyl group, a methylcyclohexyl group, a 2-ethylpropyl group, and a 2-ethylhexyl group. Of those, a sec-butyl group or a neopentyl group is preferred from the viewpoint that the colored polypropylene resin composition is excellent in high color developability, washing resistance, and sublimation resistance, and can be stably supplied.

The dialkylamino group in R₅ in the general formula (1) is not particularly limited, but examples thereof include a dimethylamino group, a diethylamino group, a dipropylamino group, and a dibutylamino group. Of those, a dimethylamino group or a diethylamino group is preferred from the viewpoint that the colored polypropylene resin composition is excellent in high color developability, washing resistance, and sublimation resistance, and can be stably supplied.

In R₅ in the general formula (1), a benzyl group is more preferred from the viewpoint that the colored polypropylene resin composition is excellent in high color developability, washing resistance, and sublimation resistance, and can be stably supplied.

Next, the compounds of the present invention can each be synthesized with reference to a known method described in a patent literature (Japanese Patent Application Laid-Open No. H08-245896). Specific examples thereof are represented by the following formulae (1-1) to (1-19), but the present invention is not limited thereto.

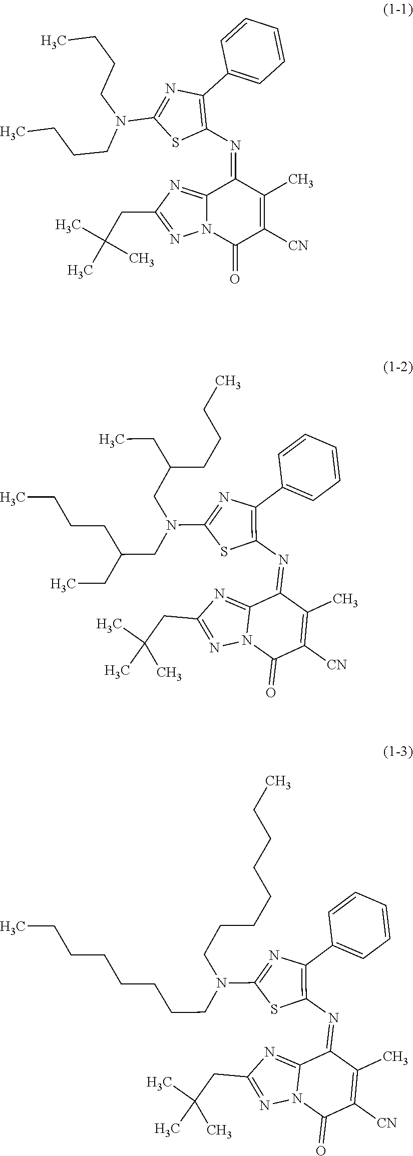 [SMILES: CCCCN(CCCC)c1nc(-c2ccccc2)c(/N=C2/C(C)=C(C#N)C(=O)n3nc(CC(C)(C)C)nc32)s1 ; CCCCC(CC)CN(CC(CC)CCCC)c1nc(-c2ccccc2)c(/N=C2/C(C)=C(C#N)C(=O)n3nc(CC(C)(C)C)nc32)s1 ; CCCCCCCCN(CCCCCCCC)c1nc(-c2ccccc2)c(/N=C2/C(C)=C(C#N)C(=O)n3nc(CC(C)(C)C)nc32)s1]

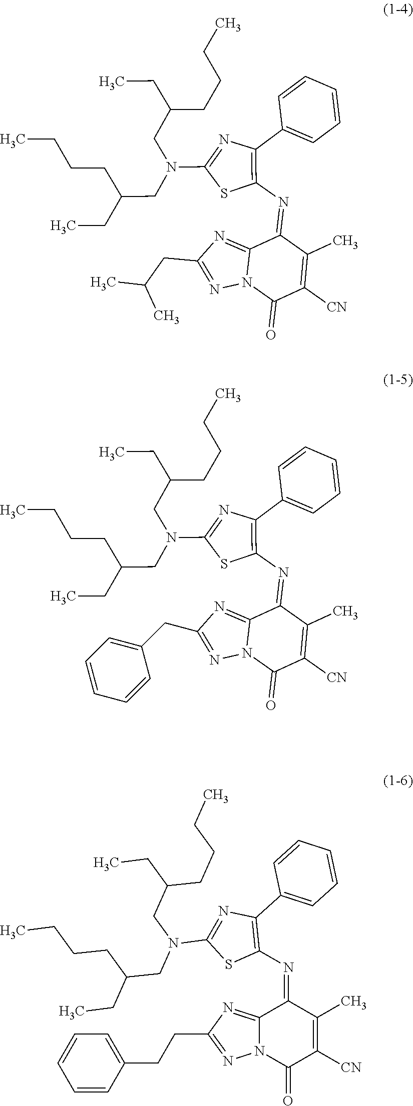 [SMILES: CCCCC(CC)CN(CC(CC)CCCC)c1nc(-c2ccccc2)c(/N=C2/C(C)=C(C#N)C(=O)n3nc(CC(C)C)nc32)s1 ; CCCCC(CC)CN(CC(CC)CCCC)c1nc(-c2ccccc2)c(/N=C2/C(C)=C(C#N)C(=O)n3nc(Cc4ccccc4)nc32)s1 ; CCCCC(CC)CN(CC(CC)CCCC)c1nc(-c2ccccc2)c(/N=C2/C(C)=C(C#N)C(=O)n3nc(CCc4ccccc4)nc32)s1]

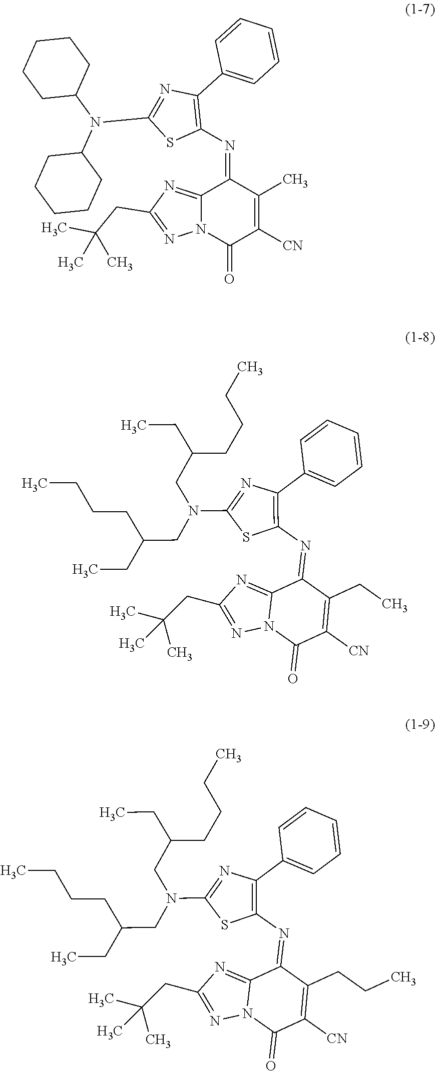

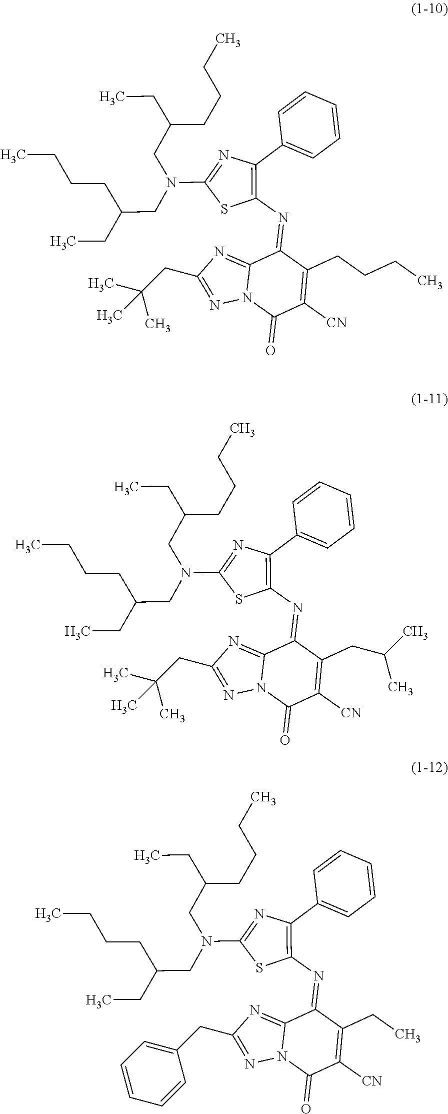

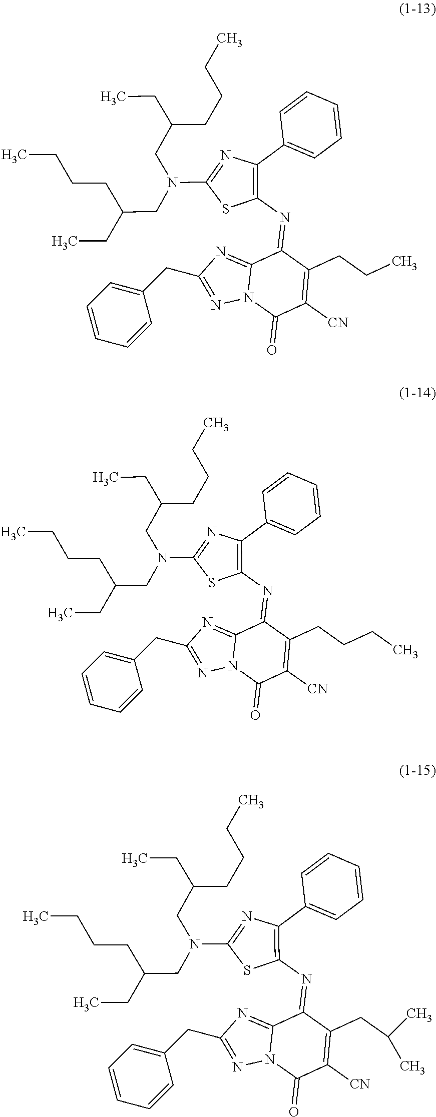

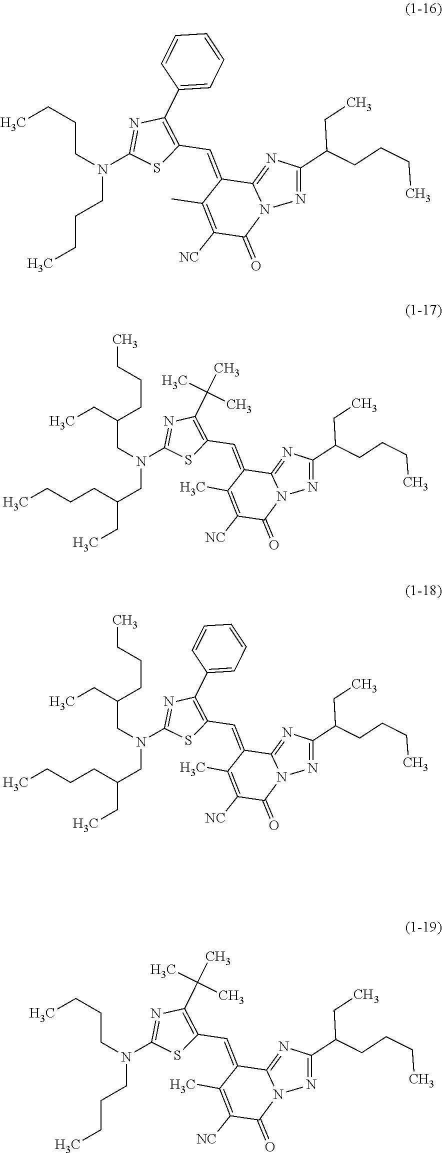

The compounds each represented by the general formula (1) may be used alone, or may be used in combination thereof for adjusting the color tone or the like of the colored polypropylene resin composition in accordance with applications.

Of those, the compound (1-1), (1-2), (1-3), (1-5), (1-16), or (1-18) is preferred because a colored polypropylene resin composition, which is excellent in high color developability, washing resistance, and sublimation resistance, and can be stably supplied, is obtained.

<Compound Represented by General Formula (2)>
Next, the compound represented by the general formula (2) is described.

The linear alkyl group having 1 to 12 carbon atoms, the branched alkyl group having 3 to 12 carbon atoms, or the cyclic alkyl group having 3 to 12 carbon atoms in each of R₆ and R₇ in the general formula (2) is not particularly limited, but examples thereof include a methyl group, an ethyl group, a n-propyl group, an iso-propyl group, a n-butyl group, a sec-butyl group, a tert-butyl group, a n-hexyl group, a n-heptyl group, a n-octyl group, a n-nonyl group, a n-decyl group, a n-undecyl group, a n-dodecyl group, a 2-ethylhexyl group, and a cyclohexyl group.

Of those, an alkyl group having 8 carbon atoms is preferred because the colored polypropylene resin composition is excellent in high color developability, washing resistance, and sublimation resistance, and can be stably supplied. In particular, a branched alkyl group such as a 2-ethylhexyl group is more preferred.

The linear alkyl group having 1 to 4 carbon atoms, or the branched alkyl group having 1 to 4 carbon atoms in R₈ in the general formula (2) is not particularly limited, but specific examples thereof include: primary alkyl groups, such as a methyl group, an ethyl group, a n-propyl group, and a n-butyl group; secondary alkyl groups, such as an iso-propyl group and a sec-butyl group; and tertiary alkyl groups such as a tert-butyl group. Of those, a tert-butyl group is preferred from the viewpoint that the colored polypropylene resin composition is excellent in high color developability, washing resistance, and sublimation resistance, and can be stably supplied.

The phenyl group having a substituent, or the unsubstituted phenyl group in R₈ in the general formula (2) is not particularly limited, but an example thereof is a substituted or unsubstituted phenyl group having 6 to 20 carbon atoms. Examples of the substituent include an alkyl group and an alkoxy group. When the phenyl group has a substituent, the number of carbon atoms represents a number including the number of carbon atoms of the substituent. In addition, the number of the substituents may be one or two or more. Specific examples of the substituted or unsubstituted phenyl group having 6 to 20 carbon atoms include a phenyl group, a 4-methylphenyl group, a 2,4-dimethylphenyl group, a 2,6-dimethylphenyl group, a 3,5-dimethylphenyl group, a 2,4,6-trimethylphenyl group, a pentamethylphenyl group, a 4-methoxyphenyl group, a 2,6-dimethoxyphenyl group, a 2,4-dimethoxyphenyl group, a 3,5-dimethoxyphenyl group, a 2,4,6-tridimethoxyphenyl group, and a naphthyl group. Of those, an unsubstituted phenyl group or a 4-methylphenyl group is preferred, and an unsubstituted phenyl group is more preferred from the viewpoint that the colored polypropylene resin composition is excellent in high color developability, washing resistance, and sublimation resistance, and can be stably supplied.

The linear or branched alkyl group having 1 to 12 carbon atoms in R₉ in the general formula (2) is not particularly limited, but specific examples thereof include a methyl group, an ethyl group, a n-propyl group, an iso-propyl group, a n-butyl group, an iso-butyl group, a 2-methylbutyl group, a 2,3,3-trimethylbutyl group, and an octyl group. Of those, a methyl group, an ethyl group, a propyl group, a n-butyl group, a 2-methylbutyl group, or a 2,3,3-trimethylbutyl group is preferred, and a methyl group is particularly preferred from the viewpoint that the colored polypropylene resin composition is excellent in high color developability, washing resistance, and sublimation resistance, and can be stably supplied.

The alkyl group in R₁₀ in the general formula (2) is not particularly limited, but an example thereof is a linear alkyl group having 1 to 12 carbon atoms, or a branched alkyl group having 1 to 12 carbon atoms. Specific examples thereof include a methyl group, an ethyl group, a n-propyl group, an iso-propyl group, a n-butyl group, an iso-butyl group, a 2-methylbutyl group, a 2,3,3-trimethylbutyl group, and an octyl group. Of those, a linear alkyl group having 1 to 4 carbon atoms, or a branched alkyl group having 1 to 4 carbon atoms is preferred, and a linear alkyl group, such as a methyl group, an ethyl group, a propyl group, or a n-butyl group, is particularly preferred from the viewpoint that the colored polypropylene resin composition is excellent in high color developability, washing resistance, and sublimation resistance, and can be stably supplied.

When R₁₀ in the general formula (2) represents —NR₁₁R₁₂, R₁₁ and R₁₂ each represent an unsubstituted alkyl group, an alkyl group having a substituent, an unsubstituted aryl group, an aryl group having a substituent, an unsubstituted acyl group, or an acyl group having a substituent.

The alkyl group represented by any one of R₁₁ and R₁₂ is not particularly limited, but an example thereof is a substituted or unsubstituted alkyl group having 1 to 20 carbon atoms. When the alkyl group has a substituent, the number of carbon atoms represents a number including the number of carbon atoms of the substituent. Specific examples of the unsubstituted alkyl group include linear, branched, or cyclic alkyl groups, such as a methyl group, an ethyl group, a n-propyl group, an iso-propyl group, a n-butyl group, a sec-butyl group, a tert-butyl group, an octyl group, a dodecyl group, a nonadecyl group, a cyclobutyl group, a cyclopentyl group, a cyclohexyl group, a methylcyclohexyl group, a 2-ethylpropyl group, and a 2-ethylhexyl group. In addition, a substituent in the substituted alkyl group is, for example, a cyclohexenyl group. Of those, an alkyl group having 1 to 4 carbon atoms is preferred, and a methyl group is particularly preferred.

The aryl group in each of R₁₁ and R₁₂ is not particularly limited, but an example thereof is a substituted or unsubstituted aryl group having 6 to 10 carbon atoms. Examples of a substituent include an alkyl group and an alkoxy group. When the aryl group has a substituent, the number of carbon atoms represents a number including the number of carbon atoms of the substituent. In addition, the number of the substituents may be one or two or more. Preferred specific examples of the substituted or unsubstituted aryl group having 6 to 10 carbon atoms include a phenyl group, a 4-methylphenyl group, and a 4-methoxyphenyl group from the viewpoint that the colored polypropylene resin composition is excellent in high color developability, washing resistance, and sublimation resistance, and can be stably supplied.

The acyl group in each of R₁₁ and R₁₂ is not particularly limited, but an example thereof is a substituted or unsubstituted acyl group having 1 to 30 carbon atoms. When the acyl group has a substituent, the number of carbon atoms represents a number including the number of carbon atoms of the substituent. Specific examples thereof include: a formyl group; a substituted or unsubstituted alkylcarbonyl group having 2 to 30 carbon atoms, such as an acetyl group, a propionyl group, or a pivaloyl group; a substituted or unsubstituted arylcarbonyl group having 7 to 30 carbon atoms, such as a benzoyl group or a naphthoyl group; and a heterocyclic carbonyl group, such as a 2-pyridylcarbonyl group or a 2-furylcarbonyl group. Of those, an acetyl group, a pivaloyl group, or a benzoyl group is preferred, and an acetyl group or a benzoyl group is more preferred from the viewpoint that the colored polypropylene resin composition is excellent in high color developability, washing resistance, and sublimation resistance, and can be stably supplied.

The ring formed by the bonding of R₁₁ and R₁₂ to each other is not particularly limited, but R₁₁ and R₁₂ represent a pyridine ring, a piperazine ring, a morpholine ring, or a phthalimide ring.

Next, a method of producing the compound represented by the general formula (2) according to the present invention is described. The compound of the present invention can be synthesized with reference to a known method described in International Publication No. WO2014/034094.

The compound represented by the general formula (2) comes in cis-trans isomers, and the isomers each fall within the scope of the present invention. The compound represented by the general formula (2) may be a mixture of the isomers.

Preferred compound examples of the compound of the present invention represented by the general formula (2) are represented by the following formulae (2-1) to (2-14), but the present invention is not limited thereto.

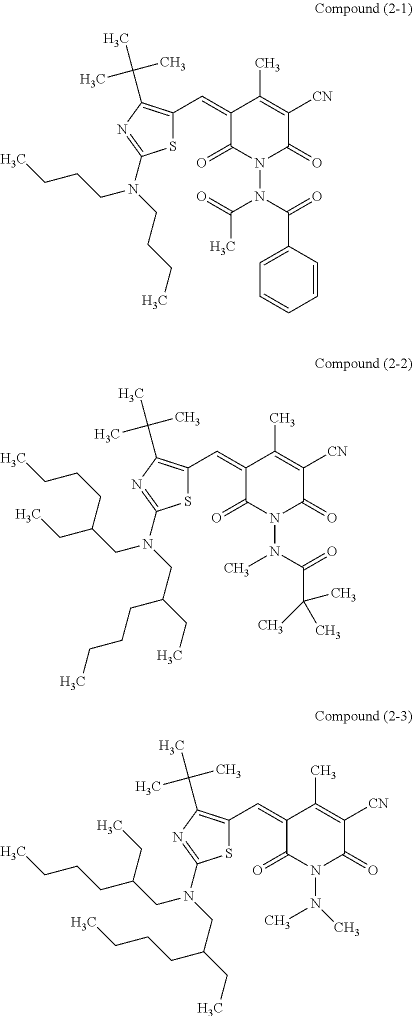

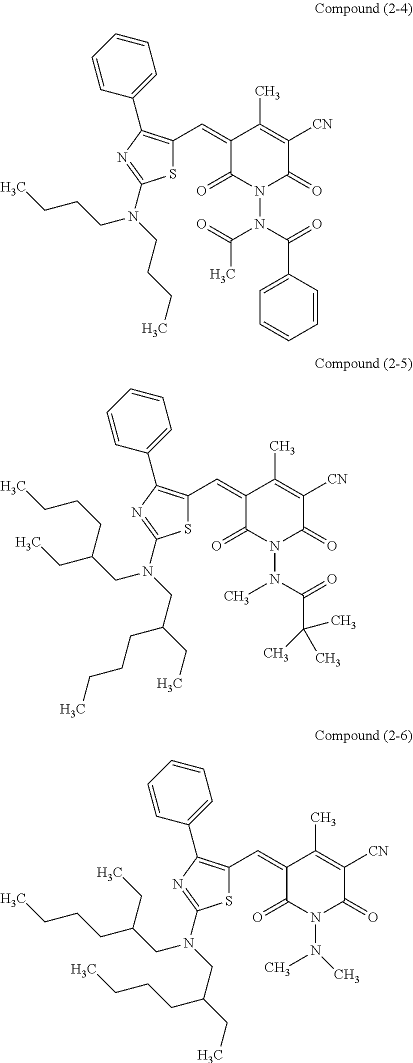

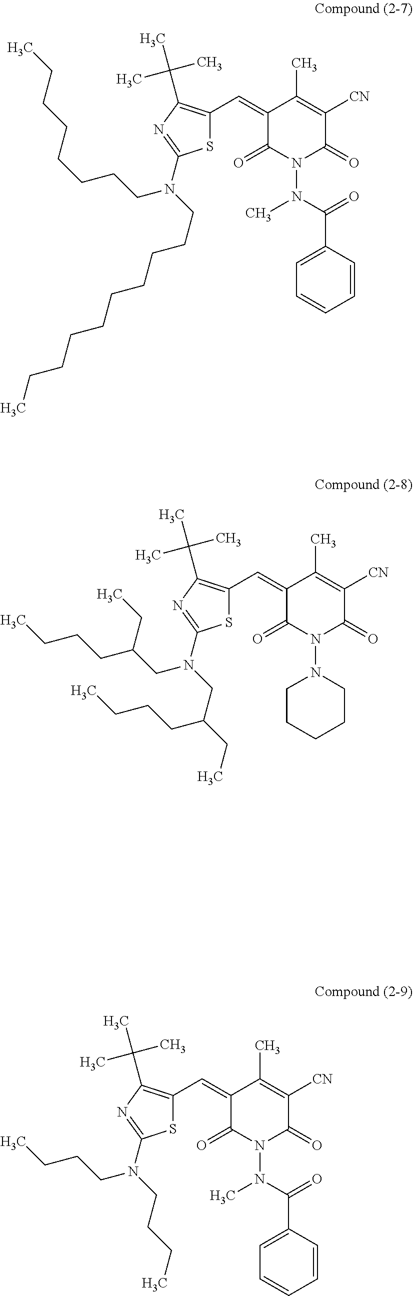

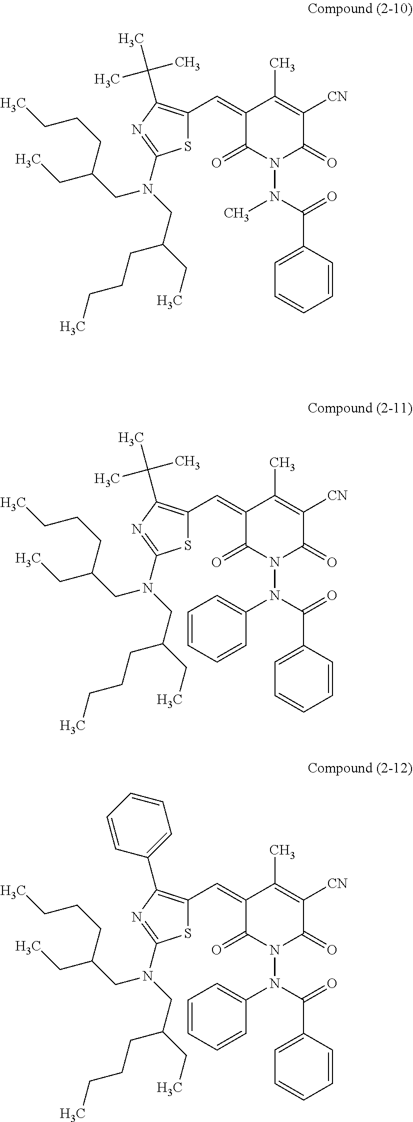

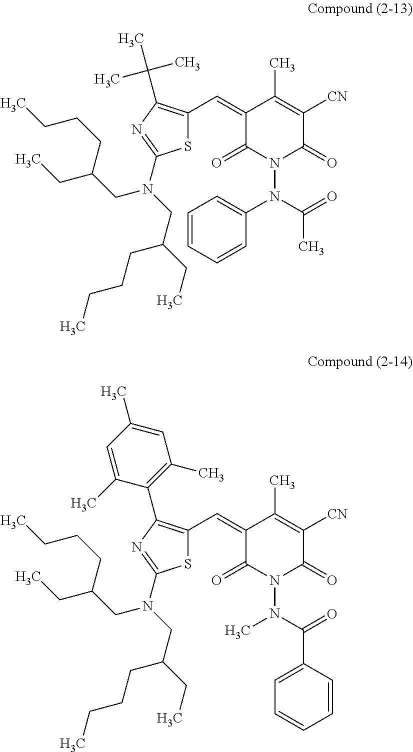

The compounds each represented by the general formula (2) may be used alone, or may be used in combination thereof for adjusting the color tone or the like of the colored polypropylene resin composition in accordance with applications.

Of those, the compound (2-1), (2-2), (2-3), (2-4), (2-7), or (2-10) is preferred because a colored polypropylene resin composition, which is excellent in high color developability, washing resistance, and sublimation resistance, and can be stably supplied, is obtained.

<Compound Represented by General Formula (3)>
Next, the compound represented by the general formula (3) is described.

The linear alkyl group having 1 to 12 carbon atoms, the branched alkyl group having 3 to 12 carbon atoms, or the cyclic alkyl group having 3 to 12 carbon atoms in each of R₁₃ and R₁₄ in the general formula (3) is not particularly limited, but examples thereof include a methyl group, an ethyl group, a n-propyl group, an iso-propyl group, a n-butyl group, a sec-butyl group, a tert-butyl group, a n-hexyl group, a n-heptyl group, a n-octyl group, a n-nonyl group, a n-decyl group, a n-undecyl group, a n-dodecyl group, a 2-ethylhexyl group, and a cyclohexyl group.

Of those, an alkyl group having 8 carbon atoms is preferred because the colored polypropylene resin composition is excellent in high color developability, washing resistance, and sublimation resistance, and can be stably supplied. In particular, a branched alkyl group such as a 2-ethylhexyl group is more preferred.

The linear alkyl group having 1 to 12 carbon atoms, or the branched alkyl group having 1 to 12 carbon atoms in R₁₅ in the general formula (3) is not particularly limited, but specific examples thereof include a methyl group, an ethyl group, a n-propyl group, an iso-propyl group, a n-butyl group, an iso-butyl group, a 2-methylbutyl group, a 2,3,3-trimethylbutyl group, and an octyl group. Of those, a methyl group, an ethyl group, a propyl group, a n-butyl group, a 2-methylbutyl group, or a 2,3,3-trimethylbutyl group is preferred, and a methyl group is particularly preferred from the viewpoint that the colored polypropylene resin composition is excellent in high color developability, washing resistance, and sublimation resistance, and can be stably supplied.

The alkyl group in R₁₆ in the general formula (3) is not particularly limited, but an example thereof is a linear alkyl group having 1 to 12 carbon atoms, or a branched alkyl group having 1 to 12 carbon atoms. Specific examples thereof include a methyl group, an ethyl group, a n-propyl group, an iso-propyl group, a n-butyl group, an iso-butyl group, a 2-methylbutyl group, a 2,3,3-trimethylbutyl group, and an octyl group. Of those, a linear alkyl group having 1 to 4 carbon atoms, or a branched alkyl group having 1 to 4 carbon atoms is preferred, and a linear alkyl group, such as a methyl group, an ethyl group, a propyl group, or a n-butyl group, is particularly preferred from the viewpoint that the colored polypropylene resin composition is excellent in high color developability, washing resistance, and sublimation resistance, and can be stably supplied.

When R₁₆ in the general formula (3) represents —NR₁₇R₁₈, R₁₇ and R₁₈ each represent an unsubstituted alkyl group, an alkyl group having a substituent, an unsubstituted aryl group, an aryl group having a substituent, an unsubstituted acyl group, or an acyl group having a substituent.

The alkyl group represented by any one of R₁₇ and R₁₈ is not particularly limited, but an example thereof is a substituted or unsubstituted alkyl group having 1 to 20 carbon atoms. When the alkyl group has a substituent, the number of carbon atoms represents a number including the number of carbon atoms of the substituent. Specific examples of the unsubstituted alkyl group include linear, branched, or cyclic alkyl groups, such as a methyl group, an ethyl group, a n-propyl group, an iso-propyl group, a n-butyl group, a sec-butyl group, a tert-butyl group, an octyl group, a dodecyl group, a nonadecyl group, a cyclobutyl group, a cyclopentyl group, a cyclohexyl group, a methylcyclohexyl group, a 2-ethylpropyl group, and a 2-ethylhexyl group. In addition, a substituent in the substituted alkyl group is, for example, a cyclohexenyl group. Of those, an alkyl group having 1 to 4 carbon atoms is preferred, and a methyl group is particularly preferred.

The aryl group in each of R₁₇ and R₁₈ is not particularly limited, but an example thereof is a substituted or unsubstituted aryl group having 6 to 10 carbon atoms. Examples of a substituent include an alkyl group and an alkoxy group. When the aryl group has a substituent, the number of carbon atoms represents a number including the number of carbon atoms of the substituent. In addition, the number of the substituents may be one or two or more. Preferred specific examples of the substituted or unsubstituted aryl group having 6 to 10 carbon atoms include a phenyl group, a 4-methylphenyl group, and a 4-methoxyphenyl group from the viewpoint that the colored polypropylene resin composition is excellent in high color developability, washing resistance, and sublimation resistance, and can be stably supplied.

The acyl group in each of R₁₇ and R₁₈ is not particularly limited, but an example thereof is a substituted or unsubstituted acyl group having 1 to 30 carbon atoms. When the acyl group has a substituent, the number of carbon atoms represents a number including the number of carbon atoms of the substituent. Specific examples thereof include: a formyl group; a substituted or unsubstituted alkylcarbonyl group having 2 to 30 carbon atoms, such as an acetyl group, a propionyl group, or a pivaloyl group; a substituted or unsubstituted arylcarbonyl group having 7 to 30 carbon atoms, such as a benzoyl group or a naphthoyl group; and a heterocyclic carbonyl group, such as a 2-pyridylcarbonyl group or a 2-furylcarbonyl group. Of those, an acetyl group, a pivaloyl group, or a benzoyl group is preferred, and an acetyl group or a benzoyl group is more preferred from the viewpoint that the colored polypropylene resin composition is excellent in high color developability, washing resistance, and sublimation resistance, and can be stably supplied.

The ring formed by the bonding of R₁₇ and R₁₈ to each other is not particularly limited, but R₁₇ and R₁₈ represent a pyridine ring, a piperazine ring, a morpholine ring, or a phthalimide ring.

The compound represented by the general formula (3) according to the present invention can be synthesized with reference to a known method described in International Publication No. WO2008/114886. The compound comes in azo-hydrazo tautomers, and the tautomers each fall within the scope of the present invention. The compound may be a mixture of the tautomers. Preferred compound examples thereof are represented by the following formulae (3-1) to (3-15) in azo body notation, but the present invention is not limited thereto.

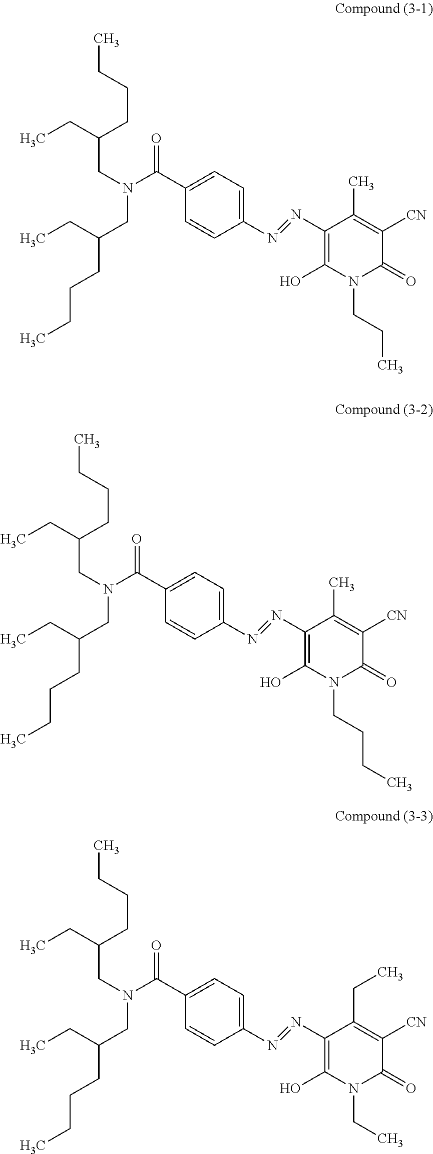 [SMILES: CCCCC(CC)CN(CC(CC)CCCC)C(=O)c1ccc(/N=N/c2c(C)c(C#N)c(=O)n(CCC)c2O)cc1 ; CCCCC(CC)CN(CC(CC)CCCC)C(=O)c1ccc(/N=N/c2c(C)c(C#N)c(=O)n(CCCC)c2O)cc1 ; CCCCC(CC)CN(CC(CC)CCCC)C(=O)c1ccc(/N=N/c2c(CC)c(C#N)c(=O)n(CC)c2O)cc1]

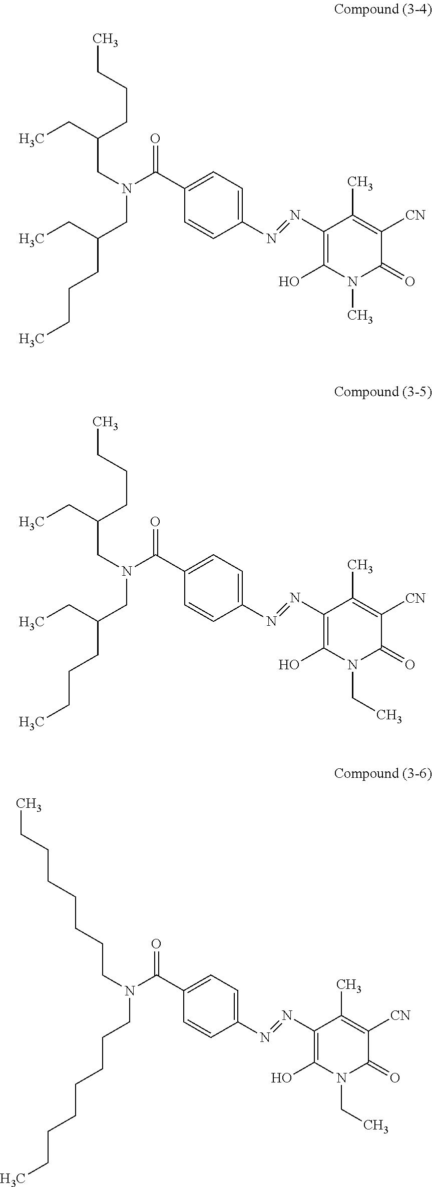 [SMILES: CCCCC(CC)CN(CC(CC)CCCC)C(=O)c1ccc(/N=N/c2c(C)c(C#N)c(=O)n(C)c2O)cc1 ; CCCCC(CC)CN(CC(CC)CCCC)C(=O)c1ccc(/N=N/c2c(C)c(C#N)c(=O)n(CC)c2O)cc1 ; CCCCCCCCN(CCCCCCCC)C(=O)c1ccc(/N=N/c2c(C)c(C#N)c(=O)n(CC)c2O)cc1]

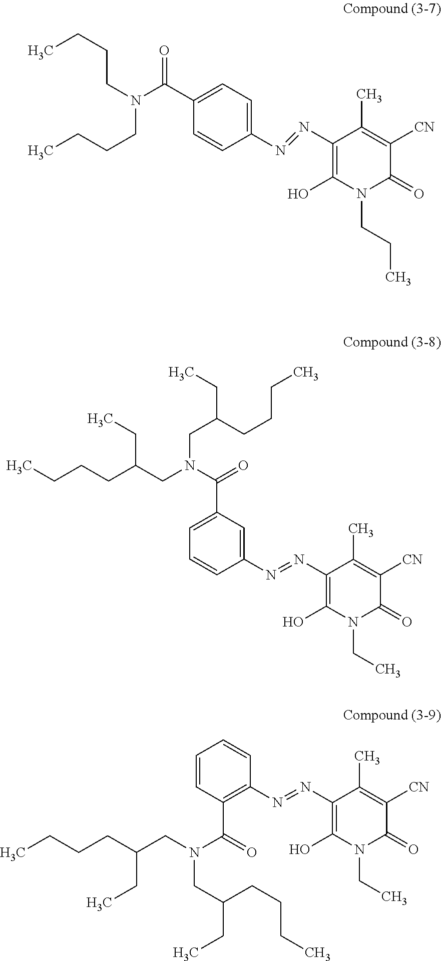 [SMILES: CCCCN(CCCC)C(=O)c1ccc(/N=N/c2c(C)c(C#N)c(=O)n(CCC)c2O)cc1 ; CCCCC(CC)CN(CC(CC)CCCC)C(=O)c1cccc(/N=N/c2c(C)c(C#N)c(=O)n(CC)c2O)c1 ; CCCCC(CC)CN(CC(CC)CCCC)C(=O)c1ccccc1/N=N/c1c(C)c(C#N)c(=O)n(CC)c1O]

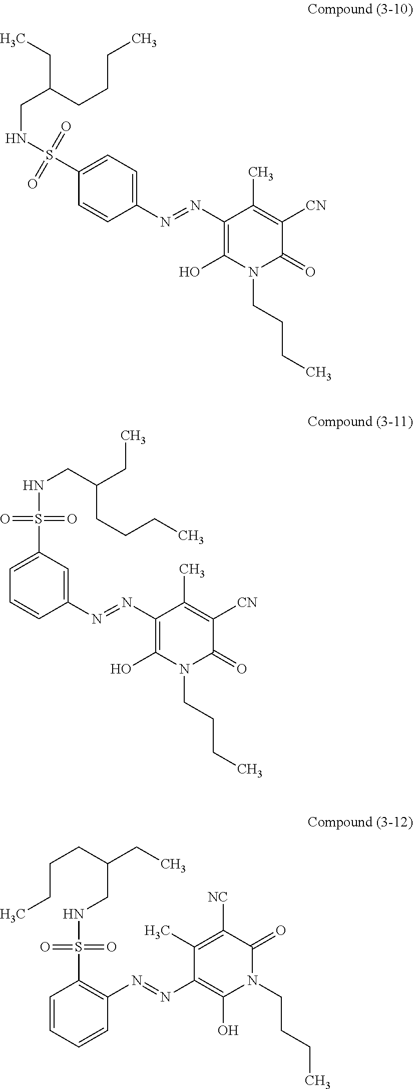 [SMILES: CCCCC(CC)CNS(=O)(=O)c1ccc(/N=N/c2c(C)c(C#N)c(=O)n(CCCC)c2O)cc1 ; CCCCC(CC)CNS(=O)(=O)c1cccc(/N=N/c2c(C)c(C#N)c(=O)n(CCCC)c2O)c1 ; CCCCC(CC)CNS(=O)(=O)c1ccccc1/N=N/c1c(C)c(C#N)c(=O)n(CCCC)c1O]

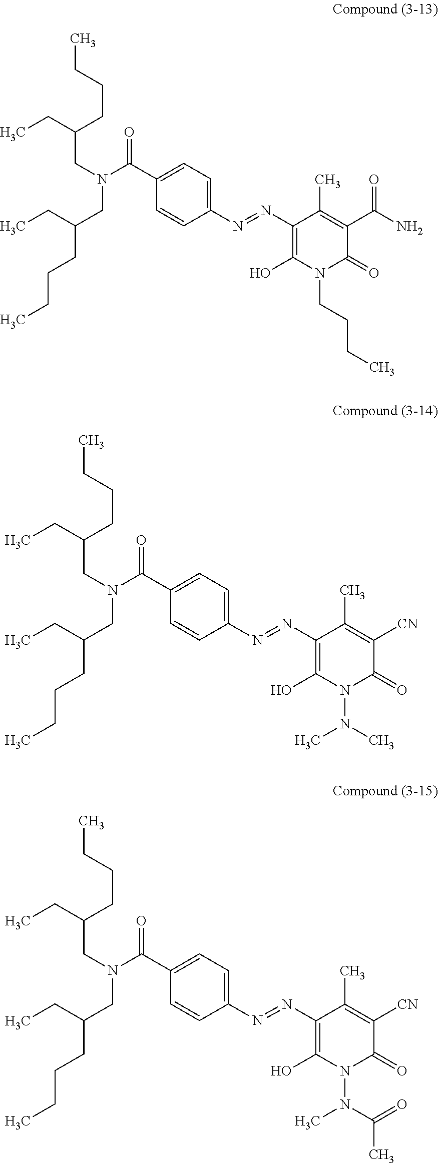 [SMILES: CCCCC(CC)CN(CC(CC)CCCC)C(=O)c1ccc(/N=N/c2c(C)c(C(N)=O)c(=O)n(CCCC)c2O)cc1 ; CCCCC(CC)CN(CC(CC)CCCC)C(=O)c1ccc(/N=N/c2c(C)c(C#N)c(=O)n(N(C)C)c2O)cc1 ; CCCCC(CC)CN(CC(CC)CCCC)C(=O)c1ccc(/N=N/c2c(C)c(C#N)c(=O)n(N(C)C(C)=O)c2O)cc1]

The compounds each represented by the general formula (3) may be used alone, or may be used in combination thereof for adjusting the color tone or the like of the colored polypropylene resin composition in accordance with applications.

Of those, the compound (3-1), (3-2), (3-5), (3-6), (3-10), or (3-14) is preferred because a colored polypropylene resin composition, which is excellent in high color developability, washing resistance, and sublimation resistance, and can be stably supplied, is obtained.

<Compound Represented by General Formula (4)>
Next, the compound represented by the general formula (4) is described.

The linear alkyl group having 1 to 12 carbon atoms, the branched alkyl group having 3 to 12 carbon atoms, or the cyclic alkyl group having 3 to 12 carbon atoms in each of R₁₉ and R₂₀ in the general formula (4) is not particularly limited, but examples thereof include a methyl group, an ethyl group, a n-propyl group, an iso-propyl group, a n-butyl group, a sec-butyl group, a tert-butyl group, a n-hexyl group, a n-heptyl group, a n-octyl group, a n-nonyl group, a n-decyl group, a n-undecyl group, a n-dodecyl group, a 2-ethylhexyl group, and a cyclohexyl group.

Of those, an alkyl group having 4 or less carbon atoms is preferred, and a methyl group, an ethyl group, a n-propyl group, or a n-butyl group is more preferred because the colored polypropylene resin composition is excellent in high color developability, washing resistance, and sublimation resistance, and can be stably supplied.

The linear alkyl group having 1 to 4 carbon atoms in R₂₁ in the general formula (4) is not particularly limited, but examples thereof include a methyl group, an ethyl group, a n-propyl group, an iso-propyl group, a n-butyl group, a sec-butyl group, and a tert-butyl group. Of those, a methyl group is preferred.

The linear alkyl group having 1 to 12 carbon atoms, or the branched alkyl group having 1 to 12 carbon atoms in R₂₂ in the general formula (4) is not particularly limited, but specific examples thereof include a methyl group, an ethyl group, a n-propyl group, an iso-propyl group, a n-butyl group, an iso-butyl group, a 2-methylbutyl group, a 2,3,3-trimethylbutyl group, and an octyl group. Of those, a methyl group, an ethyl group, a propyl group, a n-butyl group, a 2-methylbutyl group, or a 2,3,3-trimethylbutyl group is preferred, and a methyl group is particularly preferred from the viewpoint that the colored polypropylene resin composition is excellent in high color developability, washing resistance, and sublimation resistance, and can be stably supplied.

The alkyl group in each of R₂₃ and R₂₄ in the general formula (4) is not particularly limited, but an example thereof is a substituted or unsubstituted alkyl group having 1 to 20 carbon atoms. When the alkyl group has a substituent, the number of carbon atoms represents a number including the number of carbon atoms of the substituent. Specific examples of the unsubstituted alkyl group include linear, branched, or cyclic alkyl groups, such as a methyl group, an ethyl group, a n-propyl group, an iso-propyl group, a n-butyl group, a sec-butyl group, a tert-butyl group, an octyl group, a dodecyl group, a nonadecyl group, a cyclobutyl group, a cyclopentyl group, a cyclohexyl group, a methylcyclohexyl group, a 2-ethylpropyl group, and a 2-ethylhexyl group. In addition, a substituent in the substituted alkyl group is, for example, a cyclohexenyl group. Of those, an alkyl group having 1 to 4 carbon atoms is preferred, and a methyl group is particularly preferred.

The aryl group in each of R₂₃ and R₂₄ is not particularly limited, but an example thereof is a substituted or unsubstituted aryl group having 6 to 10 carbon atoms. Examples of a substituent include an alkyl group and an alkoxy group. When the aryl group has a substituent, the number of carbon atoms represents a number including the number of carbon atoms of the substituent. In addition, the number of the substituents may be one or two or more. Preferred specific examples of the substituted or unsubstituted aryl group having 6 to 10 carbon atoms include a phenyl group, a 4-methylphenyl group, and a 4-methoxyphenyl group from the viewpoint that the colored polypropylene resin composition is excellent in high color developability, washing resistance, and sublimation resistance, and can be stably supplied.

The acyl group in each of R₂₃ and R₂₄ is not particularly limited, but an example thereof is a substituted or unsubstituted acyl group having 1 to 30 carbon atoms. When the acyl group has a substituent, the number of carbon atoms represents a number including the number of carbon atoms of the substituent. Specific examples thereof include: a formyl group; a substituted or unsubstituted alkylcarbonyl group having 2 to 30 carbon atoms, such as an acetyl group, a propionyl group, or a pivaloyl group; a substituted or unsubstituted arylcarbonyl group having 7 to 30 carbon atoms, such as a benzoyl group or a naphthoyl group; and a heterocyclic carbonyl group, such as a 2-pyridylcarbonyl group or a 2-furylcarbonyl group. Of those, an acetyl group, a pivaloyl group, or a benzoyl group is preferred, and an acetyl group or a benzoyl group is more preferred from the viewpoint that the colored polypropylene resin composition is excellent in high color developability, washing resistance, and sublimation resistance, and can be stably supplied.

The ring formed by the bonding of R₂₃ and R₂₄ to each other is not particularly limited, but R₂₃ and R₂₄ represent a pyridine ring, a piperazine ring, a morpholine ring, or a phthalimide ring.

Compounds (4-1) to (4-7) are represented below as preferred examples, but the present invention is not limited to the following compounds.

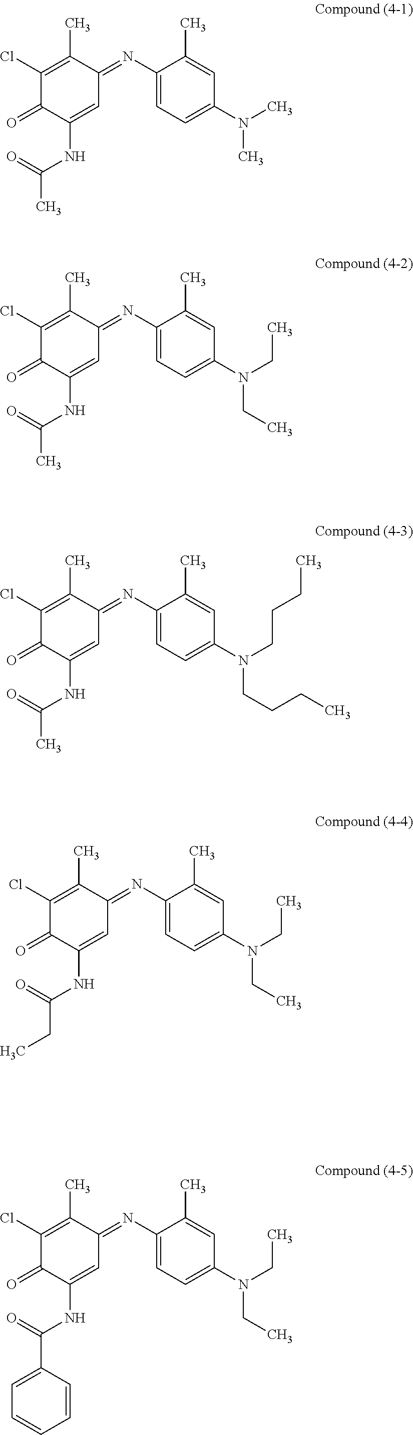 [SMILES: CC(=O)NC1=C/C(=N\c2ccc(N(C)C)cc2C)C(C)=C(Cl)C1=O ; CCN(CC)c1ccc(/N=C2\C=C(NC(C)=O)C(=O)C(Cl)=C2C)c(C)c1 ; CCCCN(CCCC)c1ccc(/N=C2\C=C(NC(C)=O)C(=O)C(Cl)=C2C)c(C)c1 ; CCC(=O)NC1=C/C(=N\c2ccc(N(CC)CC)cc2C)C(C)=C(Cl)C1=O ; CCN(CC)c1ccc(/N=C2\C=C(NC(=O)c3ccccc3)C(=O)C(Cl)=C2C)c(C)c1]

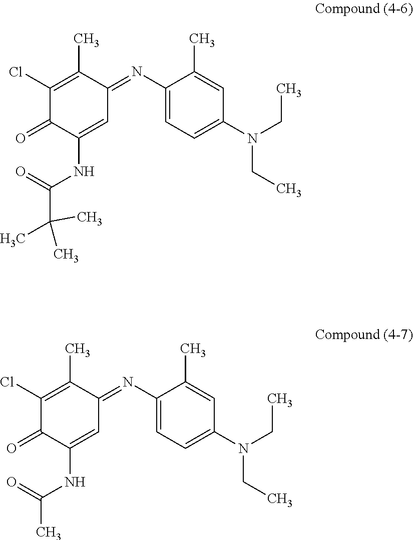 [SMILES: CCN(CC)c1ccc(/N=C2\C=C(NC(=O)C(C)(C)C)C(=O)C(Cl)=C2C)c(C)c1 ; CCN(CC)c1ccc(/N=C2\C=C(NC(C)=O)C(=O)C(Cl)=C2C)c(C)c1]

The compounds each represented by the general formula (4) may be used alone, or may be used in combination thereof for adjusting the color tone or the like of the colored polypropylene resin composition in accordance with applications.

Of those, the compound (4-1), (4-2), or (4-3) is preferred because a colored polypropylene resin composition, which is excellent in high color developability, washing resistance, and sublimation resistance, and can be stably supplied, is obtained.

<Polypropylene Resin>
Next, the polypropylene resin according to the present invention is described.

The polypropylene resin to be used in the present invention is not particularly limited, and any kind of resin may be used as long as the resin is a known polypropylene resin.

The shape of the polypropylene resin of the present invention is not particularly limited, and a fiber shape, a fine particle shape, a yarn shape, or the like is particularly preferred.

In addition, the shape may be the shape of a processed article. For example, a fabric-like fiber (e.g., a textile, a knitted fabric, a nonwoven fabric, felt, or a tuft), a yarn-like fiber (e.g., a filament yarn, a spun yarn, a slit yarn, or a split yarn), a cotton-like fiber, or a string-like fiber is suitable. Further, a commercially available polypropylene fiber may be used. In addition, a product obtained by blending and/or combining a polypropylene fiber with any other fiber made of polyester or the like may be suitably used.

Specific examples thereof may include a textile, a knitted fabric, a nonwoven fabric, clothes, underwear, socks, a glove, a zipper, a hat, sportswear, a seat, a vehicle wrapping material, shoes, a curtain, a carpet, a mat, a sofa, and a building material such as wall cloth.

<Method of producing Polypropylene Colored Resin Composition>
The present invention provides a method of producing a colored polypropylene resin composition including coloring a polypropylene resin with a colorant containing at least one or more kinds of compounds represented by the general formulae (1) to (4) in a medium, in which carbon dioxide is used as the medium, and the colorant is uniformly dispersed in the polypropylene resin by bringing the carbon dioxide into a supercritical state.

In the colored polypropylene resin composition of the present invention, an additive or the like may be appropriately added as a constituent component except the polypropylene resin and at least one or more kinds of the compounds represented by the general formulae (1) to (4) to the extent that the characteristics of the composition in its use form are not impaired.

The medium in the present invention absolutely needs to be carbon dioxide, but such a second medium as described below may be added as required (the effect of the addition is generally referred to as “entrainer effect”): a ketone solvent such as acetone; or a lower alcohol solvent, such as methanol or ethanol. The second medium is used in an amount in the range of from 0.1 vol % to 5 vol %, preferably in the range of from 0.3 vol % to 3 vol %, more preferably in the range of from 0.5 vol % to 2 vol % with respect to the internal volume of a container.

<Supercritical Carbon Dioxide Treatment>
Treatment including utilizing supercritical carbon dioxide may be performed under arbitrary conditions in accordance with the purpose of supercritical processing.

The term “supercritical carbon dioxide” as used in the present invention refers to a non-condensable high-density fluid obtained by applying a pressure of 7.38 MPa or more and a temperature of 31.1° C. or more to carbon dioxide.

A dyeing method of the present invention is described. When supercritical carbon dioxide is used as a medium, a dyeing temperature only needs to be a temperature higher than the critical temperature of carbon dioxide by 5° C. or more. The temperature falls within the range of preferably from 50° C. to 150° C., more preferably from 70° C. to 120° C. Although the dyeing of polypropylene fibers can be performed even in the case where the dyeing temperature is set to a temperature higher than 150° C., the case is not preferred because a problem such as the melting of the polypropylene fibers and an increase in production cost may occur. Meanwhile, a case in which the temperature is lower than the critical temperature of carbon dioxide is not preferred because the injection of the colorant into the polypropylene fibers does not sufficiently advance.

A dyeing pressure only needs to be not less than 7.38 MPa, which is the critical pressure of carbon dioxide, and is preferably from 12 MPa to 35 MPa, more preferably from 15 MPa to 25 MPa. When the pressure is higher than 25 MPa, an economically unpreferred problem occurs because a facility having a higher withstanding pressure is required.

A supercritical treatment time is not particularly limited, but more preferably falls within the range of from about 15 minutes or more to about 3 hours or less in typical cases.

The colorants of the present invention may be used alone or in combination thereof In addition, any other colorant such as a known dye may be used in combination to the extent that the solubility or dispersibility of the colorant in the carbon dioxide medium is not impaired.

The content of the colorant is preferably from 0.01 part by mass to 10 parts by mass, more preferably from 0.1 part by mass to 5 parts by mass, still more preferably from 0.2 part by mass to 3 parts by mass with respect to 100 parts by mass of the polypropylene resin. When the content falls within the ranges, sufficient coloring power is obtained, and the diffusibility of the colorant in the polypropylene resin becomes satisfactory. Accordingly, when a container containing the colorant and the resin is subjected to pressure release and heat release, the colorant fixes to the resin under the state of being dispersed in the resin.

### EXAMPLES

The present invention is described in more detail below by way of Examples and Comparative Examples, but the present invention is by no means limited to these Examples. The compounds were identified with a ¹H nuclear magnetic resonance (¹H-NMR) spectrometer (ECA-400, manufactured by JEOL Ltd.) and an LC/TOF MS apparatus (LC/MSD TOF, manufactured by Agilent Technologies).

<Production of Polypropylene Colored Resin Composition>
Polypropylene colored resin compositions of the present invention and comparative polypropylene colored resin compositions were produced by the following methods.

### Example 1: Production of Polypropylene Colored Resin Composition (1) (Supercritical Treatment Method)

A polypropylene fabric measuring 10 cm by 10 cm (0.45 g) was sewed up with a polyethylene yarn so as to be a cylindrical shape having an inner diameter of 1 cm. Next, 0.01 g (fabric weight×0.66 mass %) of the compound (1-1) wrapped with the polypropylene fabric and a sheet of KimWipes was loaded into a 500-milliliter supercritical fluid extraction/separation apparatus (manufactured by AKICO Corporation), and the apparatus was sealed. A temperature in the apparatus was increased to 140° C., and a pressure in the tank was adjusted to 25 MPa with carbon dioxide, followed by treatment for 60 minutes under a supercritical state. After the treatment, carbon dioxide was discharged to subject the inside of the tank to pressure release. The colored polypropylene fabric was removed from the inside of the tank, and was washed with acetone at 35° C. for 20 minutes, followed by drying. Thus, a colored polypropylene resin composition (1) was obtained.

### Examples 2 to 21: Production of Polypropylene Colored Resin Compositions (2) to (21), Comparative Examples 1 to 3: Production of Comparative Polypropylene Colored Resin Compositions (1) to (3)

Polypropylene colored resin compositions (2) to (21) and comparative polypropylene colored resin compositions (1) to (3) were each obtained in the same manner as in Example 1 except that in Example 1, the compound represented by the general formula (1-1) and the production conditions (the pressure, the temperature, the holding time, and a medium 2) were changed to those shown in Table 1. The following compounds were used as comparative compounds.

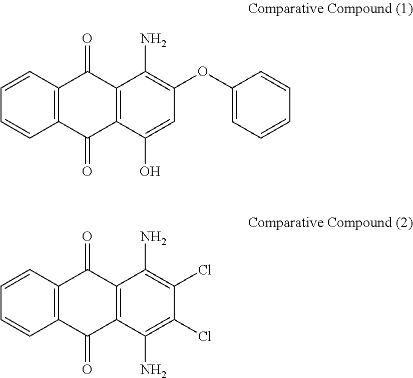

Each of the resultant polypropylene colored resin compositions was subjected to the following evaluations. The results are shown in Table 2.

[Chroma Evaluation]
A standard white plate was placed under each of the colored polypropylene resin compositions obtained in the foregoing, and the values of the L*, a*, and b* of the composition were measured with a spectral densitometer (fluorescence spectral densitometer FD-7, manufactured by Konica Minolta, Inc.). The chroma (C*) of the composition was determined from the resultant values of the L*, the a*, and the b* based on the following equation, and was evaluated.

C*=((a*)²+(b*)²)^{1/2}

As the chroma C* becomes larger, it can be said that the growth of the chroma becomes more satisfactory, and hence the composition has a higher chroma.
AA: The C* is 70 or more.
A: The C* is 50 or more and less than 70.
B: The C* is 30 or more and less than 50.
C: The C* is less than 30.

[Washing Fastness Evaluation]
The washing fastness (staining resistance out of the staining resistance and a change in color) of each of the colored polypropylene resin compositions obtained in the foregoing was evaluated in conformity with a washing fastness test method JIS L0844 A-2. Specifically, the colored polypropylene resin composition in the foregoing was sewn onto a white multifiber test fabric (test fabric No. 1: in conformity with JIS L0803, a fabric woven with cotton, nylon, acetate, hair, rayon, acrylic, silk, and polyester), and the sewn fabric was washed in a laundry teste, and dried after washing. Specifically, the colored polypropylene resin compositions obtained in the foregoing was applied to a white multifiber test fabric (test fabric No. 1: in conformity with JIS L0803, a fabric woven with cotton, nylon, acetate, hair, rayon, acrylic, silk, and polyester), which was then sewn onto the fabric, washed in a laundry tester, and dried after washing. The most stained portion of the dried multifiber test fabric was evaluated for its staining resistance with respect to a gray scale for staining. In the test, the evaluation is performed on the following 9 scales: a 5th grade, a 4th-to-5th grade, a 4th grade, a 3rd-to-4th grade, a 3rd grade, a 2nd-to-3rd grade, a 2nd grade, a 1st-to-2nd grade, and a 1st grade. A state in which the evaluation result is closer to the 5th grade means that the color of the most stained portion is closer to a white color, in other words, the staining was suppressed to a larger extent.
A: The 4th grade or more
B: The 2nd-to-3rd grade or more and less than the 4th grade
C: The 2nd grade or less

[Sublimation Fastness Evaluation]
The sublimation fastness (staining resistance out of the staining resistance and a change in color) of each of the colored polypropylene resin compositions obtained in the foregoing was evaluated in conformity with JIS L0854. The evaluation was performed by using nylon (monofilament fabric (I) No. 7: JIS L0803:2005) as a standard adjacent fabric with respect to a gray scale for staining. In the test, the evaluation is performed on the following 9 scales: a 5th grade, a 4th-to-5th grade, a 4th grade, a 3rd-to-4th grade, a 3rd grade, a 2nd-to-3rd grade, a 2nd grade, a 1st-to-2nd grade, and a 1st grade. A state in which the evaluation result is closer to the 5th grade means that the color of the most stained portion is closer to a white color, in other words, the staining was suppressed to a larger extent.
A: The 4th grade to the 5th grade
B: The 2nd-to-3rd grade to the 3rd-to-4th grade
C: The 1st grade to the 2nd grade

TABLE 1

| | Color | | | | | | |
|---|---|---|---|---|---|---|---|
| | provided | | | | Holding | | |
| | by | | Temperature | Pressure | time | | |
| | compound | Compound | (° C.) | (MPa) | (minute(s)) | Medium 1 | Medium 2 |
| Example 1 | Cyan | 1-1 | 140 | 25 | 60 | Carbon dioxide | — |
| Example 2 | Cyan | 1-5 | 130 | 25 | 60 | Carbon dioxide | Acetone/5 mL |
| Example 3 | Cyan | 1-5 | 130 | 25 | 60 | Carbon dioxide | Ethanol/25 mL |
| Example 4 | Magenta | 2-2 | 120 | 25 | 40 | Carbon dioxide | — |
| Example 5 | Magenta | 2-10 | 120 | 25 | 60 | Carbon dioxide | — |
| Example 6 | Yellow | 3-5 | 120 | 25 | 60 | Carbon dioxide | — |
| Example 7 | Yellow | 3-10 | 130 | 25 | 60 | Carbon dioxide | — |
| Example 8 | Red | 2-10/3-5 | 120 | 25 | 60 | Carbon dioxide | — |
| | (Magenta/ | (blending ratio: | | | | | |
| | cyan) | 2/1) | | | | | |
| Example 9 | Cyan | 4-2 | 120 | 25 | 20 | Carbon dioxide | Ethanol/5 mL |
| Example 10 | Magenta | 2-10 | 120 | 25 | 20 | Carbon dioxide | — |
| Example 11 | Magenta | 2-10 | 120 | 20 | 20 | Carbon dioxide | — |
| Example 12 | Magenta | 2-10 | 100 | 20 | 20 | Carbon dioxide | — |
| Example 13 | Magenta | 2-10 | 80 | 15 | 20 | Carbon dioxide | Ethanol/2 mL |
| Example 14 | Cyan | 1-16 | 120 | 25 | 20 | Carbon dioxide | Ethanol/10 mL |
| Example 15 | Cyan | 1-18 | 120 | 25 | 20 | Carbon dioxide | Ethanol/10 mL |
| Example 16 | Green | 3-5/4-2 | 120 | 25 | 45 | Carbon dioxide | — |
| | (Yellow/ | (blending ratio: | | | | | |
| | cyan) | 1/2) | | | | | |
| Example 17 | Orange | 3-5/2-10 | 120 | 25 | 45 | Carbon dioxide | — |
| | (Yellow/ | (blending ratio: | | | | | |
| | magenta) | 1/2) | | | | | |
| Example 18 | Magenta | 2-1 | 120 | 25 | 20 | Carbon dioxide | Acetone/5 mL |
| Example 19 | Magenta | 2-10 | 80 | 25 | 15 | Carbon dioxide | — |
| Example 20 | Yellow | 3-5 | 80 | 25 | 15 | Carbon dioxide | — |
| Example 21 | Cyan | 4-2 | 80 | 25 | 20 | Carbon dioxide | Ethanol/5 mL |
| Comparative | Magenta | Comparative | 120 | 25 | 20 | Carbon dioxide | — |
| Example 1 | | Compound (1) | | | | | |
| Comparative | Magenta | Comparative | 120 | 25 | 20 | Carbon dioxide | Ethanol/5 mL |
| Example 2 | | Compound (1) | | | | | |
| Comparative | Yellow | Comparative | 140 | 25 | 20 | Carbon dioxide | Ethanol/5 mL |
| Example 3 | | Compound (2) | | | | | |

TABLE 2

| | | | | | Sublimation | |
|---|---|---|---|---|---|---|
| | | | Washing | | fastness test | |
| | Chroma | | fastness evaluation | | evaluation | |
| | evaluation | | Staining | | Staining | |
| | C* | Rank | resistance | Rank | resistance | Rank |
| Example 1 | 32 | B | 4th grade | A | 4th grade | A |
| Example 2 | 40 | B | 5th grade | A | 4th-to-5th grade | A |
| Example 3 | 52 | A | 4th-to-5th grade | A | 4th-to-5th grade | A |
| Example 4 | 68 | A | 4th grade | A | 4th-to-5th grade | A |
| Example 5 | 72 | AA | 4th-to-5th grade | A | 4th-to-5th grade | A |
| Example 6 | 91 | AA | 4th grade | A | 4th grade | A |
| Example 7 | 61 | A | 3rd grade | B | 4th-to-5th grade | A |
| Example 8 | 71 | AA | 4th grade | A | 4th grade | A |
| Example 9 | 45 | B | 4th-to-5th grade | A | 4th-to-5th grade | A |
| Example 10 | 76 | AA | 4th-to-5th grade | A | 4th grade | A |
| Example 11 | 71 | AA | 4th-to-5th grade | A | 4th grade | A |
| Example 12 | 72 | AA | 4th-to-5th grade | A | 4th grade | A |
| Example 13 | 70 | AA | 4th grade | A | 4th grade | A |
| Example 14 | 44 | B | 4th-to-5th grade | A | 4th-to-5th grade | A |
| Example 15 | 46 | B | 4th-to-5th grade | A | 4th-to-5th grade | A |
| Example 16 | 55 | A | 4th grade | A | 4th grade | A |
| Example 17 | 75 | AA | 4th-to-5th grade | A | 4th-to-5th grade | A |
| Example 18 | 70 | A | 4th grade | A | 4th grade | A |
| Example 19 | 71 | AA | 4th-to-5th grade | A | 4th-to-5th grade | A |
| Example 20 | 90 | AA | 4th grade | A | 4th grade | A |
| Example 21 | 43 | B | 4th-to-5th grade | A | 4th-to-5th grade | A |
| Comparative | 40 | B | 2nd grade | C | 1st-to-2nd grade | C |
| Example 1 | | | | | | |
| Comparative | 25 | C | 2nd-to-3rd grade | B | 2nd grade | C |
| Example 2 | | | | | | |
| Comparative | 18 | C | 2nd-to-3rd grade | B | 1st-to-2nd grade | C |
| Example 3 | | | | | | |

As shown in Table 2, it is apparent that the colored polypropylene resin compositions of Examples are superior in all of high color developability, washing resistance, and sublimation resistance to the comparative colored resin compositions.

The colored polypropylene resin composition of the present invention is excellent in high color developability, washing resistance, and sublimation resistance, and can be stably supplied. The colored polypropylene resin composition may be suitably used in, for example, a textile, a knitted fabric, a nonwoven fabric, clothes, underwear, socks, a glove, a zipper, a hat, sportswear, a seat, a vehicle wrapping material, shoes, a curtain, a carpet, a rope, a tent, a mat, a sofa, or a building material such as wall cloth.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-083562, filed May 18, 2021, and Japanese Patent Application No. 2022-057944, filed Mar. 31, 2022, which are hereby incorporated by reference herein in their entirety.

What is claimed is:

1. A colored polypropylene resin composition comprising:
a polypropylene resin; and
a colorant,
wherein the colorant contains at least one or more kinds of compounds represented by the following general formulae (1) to (4): 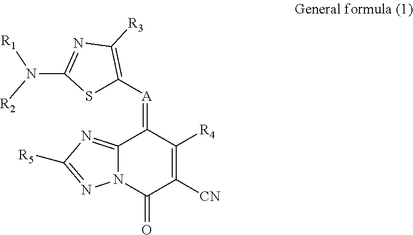
in the general formula (1),
R₁ and R2 each independently represent an alkyl group having 1 to 12 carbon atoms,
R₃ represents an alkyl group having 1 to 4 carbon atoms, a phenyl group having a substituent, or an unsubstituted phenyl group,
R₄ represents an alkyl group having 1 to 4 carbon atoms, or an unsubstituted phenyl group,
R₅ represents an alkyl group having 1 to 12 carbon atoms, an unsubstituted phenyl group, a benzyl group, a dialkylamino group, or a diphenylamino group, and
A represents a carbon atom or a nitrogen atom, and when A represents a carbon atom, one hydrogen atom is bonded to the carbon atom; 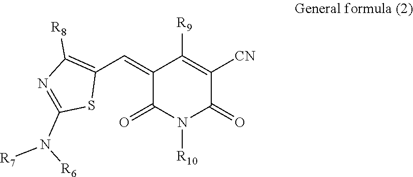
in the general formula (2),
R₆ and R₇ each independently represent a linear alkyl group having 1 to 12 carbon atoms, a branched alkyl group having 3 to 12 carbon atoms, or a cyclic alkyl group having 3 to 12 carbon atoms,
R₈ represents a linear alkyl group having 1 to 4 carbon atoms, a branched alkyl group having 1 to 4 carbon atoms, a phenyl group having a substituent, or an unsubstituted phenyl group,
R₉ represents a linear alkyl group having 1 to 12 carbon atoms, or a branched alkyl group having 1 to 12 carbon atoms,
R₁₀ represents a hydrogen atom, an alkyl group, an aryl group, a benzyl group, or —NR₁₁R₁₂, and
R₁₁ and R₁₂ each independently represent a hydrogen atom, an unsubstituted alkyl group, an alkyl group having a substituent, an unsubstituted aryl group, an aryl group having a substituent, an unsubstituted acyl group, or an acyl group having a substituent, and R₁₁ and R₁₂ represent a ring formed by bonding thereof to each other; 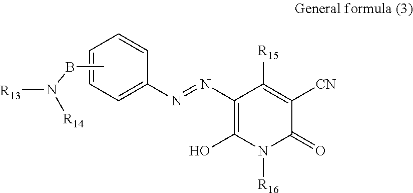
in the general formula (3),
B represents a carbonyl group or a sulfonyl group,
R₁₃ and R₁₄ each independently represent a linear alkyl group having 1 to 12 carbon atoms, a branched alkyl group having 3 to 12 carbon atoms, or a cyclic alkyl group having 3 to 12 carbon atoms,
R₁₅ represents a linear alkyl group having 1 to 12 carbon atoms, or a branched alkyl group having 1 to 12 carbon atoms,
R₁₆ represents a hydrogen atom, an alkyl group, an aryl group, a benzyl group, or —NR₁₇R₁₈, and
R₁₇ and R₁₈ each independently represent a hydrogen atom, an unsubstituted alkyl group, an alkyl group having a substituent, an unsubstituted aryl group, an aryl group having a substituent, an unsubstituted acyl group, or an acyl group having a substituent, and R₁₇ and R₁₈ represent a ring formed by bonding thereof to each other; 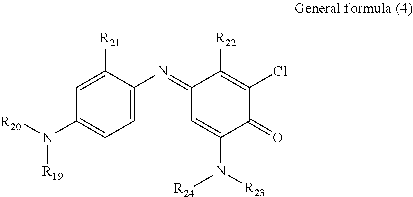
in the general formula (4),
R₁₉ and R₂₀ each independently represent a linear alkyl group having 1 to 12 carbon atoms, a branched alkyl group having 3 to 12 carbon atoms, or a cyclic alkyl group having 3 to 12 carbon atoms, and R₂₁ represents a linear alkyl group having 1 to 4 carbon atoms,
R₂₂ represents a linear alkyl group having 1 to 12 carbon atoms, or a branched alkyl group having 1 to 12 carbon atoms, and
R₂₃ and R₂₄ each independently represent a hydrogen atom, an unsubstituted alkyl group, an alkyl group having a substituent, an unsubstituted aryl group, an aryl group having a substituent, an unsubstituted acyl group, or an acyl group having a substituent, and R₂₃ and R₂₄ represent a ring formed by bonding thereof to each other.

2. The colored polypropylene resin composition according to claim 1, wherein a shape of the polypropylene resin is one of a fiber shape, a fine particle shape, or a yarn shape.

3. The colored polypropylene resin composition according to claim 1, wherein R₁ and R₂ of the compound represented by the general formula (1), R₆ and R₇ of the compound represented by the general formula (2), and R₁₃ and R₁₄ of the compound represented by the general formula (3) each represent a 2-ethylhexyl group.

4. A method of producing a colored polypropylene resin composition comprising coloring a polypropylene resin with a colorant in a medium,
wherein the medium to be used is supercritical carbon dioxide, and
wherein the colorant contains at least one or more kinds of compounds represented by the following general formulae (1) to (4): 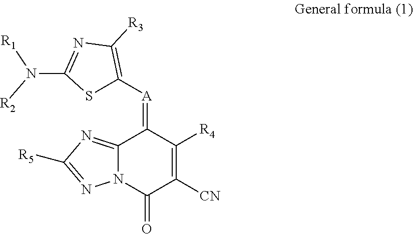
in the general formula (1),
R₁ and R₂ each independently represent an alkyl group having 1 to 12 carbon atoms,
R₃ represents an alkyl group having 1 to 4 carbon atoms, a phenyl group having a substituent, or an unsubstituted phenyl group,
R₄ represents an alkyl group having 1 to 4 carbon atoms, or an unsubstituted phenyl group,
R₅ represents an alkyl group having 1 to 12 carbon atoms, an unsubstituted phenyl group, a benzyl group, a dialkylamino group, or a diphenylamino group, and
A represents a carbon atom or a nitrogen atom, and when A represents a carbon atom, one hydrogen atom is bonded to the carbon atom; 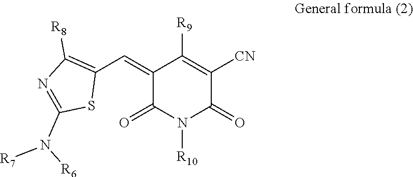
in the general formula (2),
R₆ and R₇ each independently represent a linear alkyl group having 1 to 12 carbon atoms, a branched alkyl group having 3 to 12 carbon atoms, or a cyclic alkyl group having 3 to 12 carbon atoms,
R₈ represents a linear alkyl group having 1 to 4 carbon atoms, a branched alkyl group having 1 to 4 carbon atoms, a phenyl group having a substituent, or an unsubstituted phenyl group,
R₉ represents a linear alkyl group having 1 to 12 carbon atoms, or a branched alkyl group having 1 to 12 carbon atoms,
R₁₀ represents a hydrogen atom, an alkyl group, an aryl group, a benzyl group, or —NR₁₁R₁₂, and
R₁₁ and R₁₂ each independently represent a hydrogen atom, an unsubstituted alkyl group, an alkyl group having a substituent, an unsubstituted aryl group, an aryl group having a substituent, an unsubstituted acyl group, or an acyl group having a substituent, and R₁₁ and R₁₂ represent a ring formed by bonding thereof to each other; 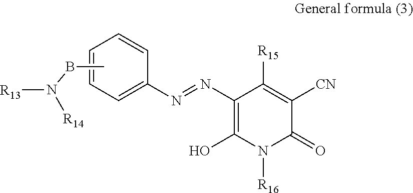
in the general formula (3),
B represents a carbonyl group or a sulfonyl group,
R₁₃ and R₁₄ each independently represent a linear alkyl group having 1 to 12 carbon atoms, a branched alkyl group having 3 to 12 carbon atoms, or a cyclic alkyl group having 3 to 12 carbon atoms,
R₁₅ represents a linear alkyl group having 1 to 12 carbon atoms, or a branched alkyl group having 1 to 12 carbon atoms,
R₁₆ represents a hydrogen atom, an alkyl group, an aryl group, a benzyl group, or —NR₁₇R₁₈, and
R₁₇ and R₁₈ each independently represent a hydrogen atom, an unsubstituted alkyl group, an alkyl group having a substituent, an unsubstituted aryl group, an aryl group having a substituent, an unsubstituted acyl group, or an acyl group having a substituent, and R₁₇ and R₁₈ represent a ring formed by bonding thereof to each other; 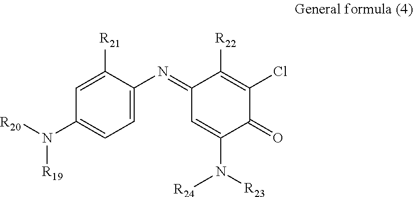
in the general formula (4),
R₁₉ and R₂₀ each independently represent a linear alkyl group having 1 to 12 carbon atoms, a branched alkyl group having 3 to 12 carbon atoms, or a cyclic alkyl group having 3 to 12 carbon atoms, and R₂₁ represents a linear alkyl group having 1 to 4 carbon atoms,
R₂₂ represents a linear alkyl group having 1 to 12 carbon atoms, or a branched alkyl group having 1 to 12 carbon atoms, and
R₂₃ and R₂₄ each independently represent a hydrogen atom, an unsubstituted alkyl group, an alkyl group having a substituent, an unsubstituted aryl group, an aryl group having a substituent, an unsubstituted acyl group, or an acyl group having a substituent, and R₂₃ and R₂₄ represent a ring formed by bonding thereof to each other.

5. The method of producing a colored polypropylene resin composition according to claim 4, wherein the supercritical carbon dioxide serving as the medium has added thereto one of a lower alcohol or a ketone.
